(19) United States
(12) Patent Application Publication
(10) Pub. No.: US 2007/0250430 A1
(43) Pub. Date: Oct. 25, 2007

(54) Peer-to-peer based marketplaces

(76) Inventors: Steven Sholtis, El Dorado Hills, CA (US); Jim Del Favero, Redwood City, CA (US); Kenneth Henderson, Folsom, CA (US)

Correspondence Address: GUNNISON, MCKAY & HODGSON, L.L.P., 1900 GARDEN ROAD, SUITE 220, MONTEREY, CA, 93940, US

(21) Appl. No.: 11/407,469

(22) Filed: Apr. 19, 2006

(51) Int. Cl. G06Q 40/00

(52) U.S. Cl. 705/37

(57) ABSTRACT

In various embodiments, the present invention provides methods and systems for buying and selling goods and services over a peer-to-peer network. Multiple client devices are connected as peer nodes within a P2P network. Active P2P network nodes register with a server as they come online. The server stores information about the types of goods and services that are available from each registered peer and the routing information needed to contact that peer. A peer acting as a buyer, referred to herein as a buyer, can query the server and receive a list of peers with offerings of a desired type along with the necessary routing information for those peers. The buyer can then query each peer on the list and receive details about that peer's offerings. The buyer can choose to execute a sales transaction with a selected peer if that peer's offerings meet with the buyer's approval.

### BACKGROUND

This invention relates to systems and methods for online sales of goods and services. Traditionally, on-line sales of goods and services, i.e. eCommerce, has been accomplished through customized websites developed for individual businesses. Significant time and resources are invested in building, maintaining, and advertising a company's web presence. The benefits from this investment are largely limited to the company's ability to stand out in a sea of Internet search results and advertisements, or to have a website address memorable enough that customers independently recall it.

Small businesses and individuals generally lack the ability to pool their resources into “virtual” organizations with enough buying power or selling power to compete with larger companies. Those who have the ability to pool resources cannot easily extricate themselves from an online partnership because of their investment in web presence; the proliferation of web search engines, such as Google, make it more difficult for a “virtual” organization or its members to “disappear” from the web when the partnership is no longer valid. The high barriers to entry into the online marketplace through a customized website and the uncertain returns on that investment have caused some, particularly small businesses and individuals, to turn to alternatives to make online sales.

One alternative is a centralized electronic bulletin board, such as craigslist.com, with listings in categories similar to the classified section of a newspaper. Another alternative is to list items for sale on a centralized auction service such as Ebay. Users who list items or information on these websites and with these services surrender some control over their information. The users must abide by the rules of the service or website or portal administrator to update or delete items or information. In addition, an intermediary may charge a fee to administer the website or portal in order to recoup his own costs of building, maintaining, and advertising the website or portal. If multiple users wish to form their own “virtual” organization, the individual users must establish a web presence which links them to the portal, or additional infrastructure must be added to the portal to support such online communities—either option adds significant on-going costs and maintenance.

### SUMMARY

In various embodiments, the present invention provides methods and systems for selling goods and services over peer-to-peer (P2P) networks. Multiple client devices are connected as peer nodes within a P2P network. Active P2P network nodes register with a server. The server stores information about the types of goods and services that are available from each registered peer and the routing information needed to contact that peer. A peer acting as a buyer, referred to herein as a buyer, can request from the server and receive a list of peers with offerings of a desired type along with the necessary routing information for those peers. The buyer can then query one or more of the peers on the list and receive details about that peer's offerings, including any content, information, or documents related to that peer's offering that the peer desires to share. The buyer can select one or more peers, and to execute a sales transaction with a selected peer.

In one variation, embodiments of the present invention facilitate the donation of items to charitable organizations. Donors list items for donation. A representative of a charity can search the peer network for items that meet the charity's needs and contact the donors directly to arrange the transfer.

In another variation, embodiments of the present invention facilitate the scheduling of appointments. Individuals or businesses list their availability. A customer can search the peer network for a time slot that meets the customer's needs and contact the individual or business directly to make an appointment.

### BRIEF DESCRIPTION OF THE DRAWINGS

FIG. 1 is an illustration of one embodiment of a peer-to-peer network.

FIG. 2A is an illustration of one embodiment of a peer-to-peer network suitable for buying and selling goods.

FIG. 2B is a flow chart of one embodiment of a method for buying and selling goods over a peer-to-peer network.

FIG. 3 is an illustration of one embodiment of a user interface used to sell items in a peer-to-peer network.

FIG. 4 is an illustration of one embodiment of a user interface used to buy items in a peer-to-peer network.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

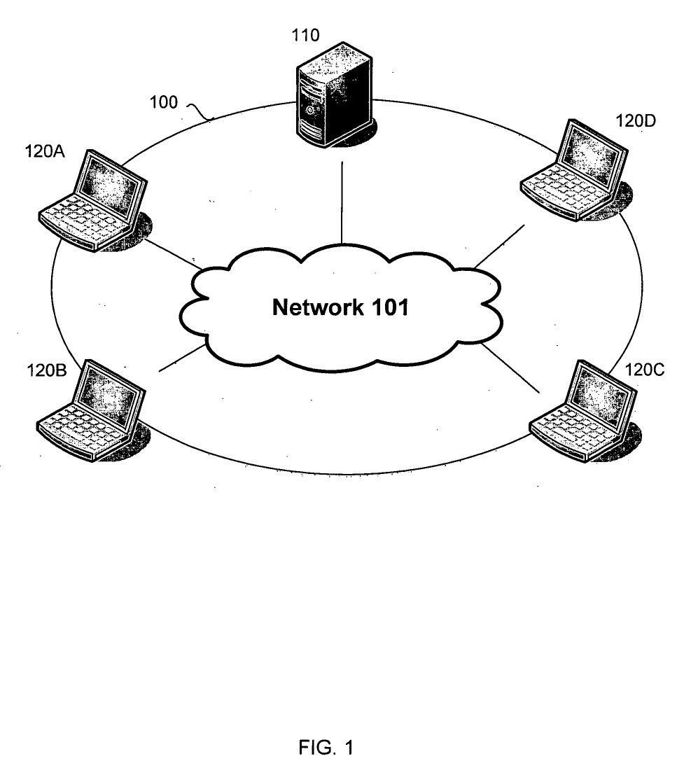

FIG. 1 shows one embodiment of a peer-to-peer network 100. The peer-to-peer network 100 comprises peer nodes 110, 120 connected by a network 101. The peers comprise a peer acting as a server 110 and peer client devices 120. The server 110 can be, for example, a routing server having storage for storing routing information for each of the peer client devices 120 in the peer network 100. The server 110 can also store data from each of the peer client devices 120 to describe the types of offerings that each peer wants to make known to the other peers. Accordingly, the server 110 comprises a receiving module for receiving queries from peer client devices 120 for routing information to peer client devices with offerings of a selected type, and a transmitting module for sending information in response to queries. Peer client devices 120 can be computers, cell phones, personal digital assistants (PDAs) or any other electronic device capable of communicatively coupling to the network 101.

In one embodiment, peer client devices 120 run a P2P marketplace software application (not shown). Users of the P2P marketplace software application can store files, database records, or other information describing the user's marketplace offerings, query the server 110 and other peer client devices 120 for offerings matching specified types and/or criteria from the offerings of other users, and review the result sets from the user's queries to select an offering to acquire, reserve, buy, sell, barter, bid on or otherwise identify an offering for a transaction with the offeror. The software applications enable each peer client device 120 to communicate with the server 110 and all other peer client devices 120 through the network 101. Network 101 can be any network, such as the Internet, a LAN, a MAN, a WAN, a wired or wireless network, a private network, or a virtual private network.

In the example shown in FIG. 1, the P2P marketplace is implemented in a hybrid P2P network, but other types of P2P networks are also possible in other embodiments. In a hybrid P2P network, a central server stores information on peers and responds to requests for that information, but the peers host the information about the offerings that are shared over the P2P network. The P2P marketplace can also be implemented over a pure P2P network, where peers act as clients and server, and there is no central server managing the network. In another embodiment, the P2P marketplace can be implemented over a mixed P2P network that has characteristics of both pure and hybrid P2P networks.

Although four peer client devices 120 are shown in the example of FIG. 1, in alternate embodiments more or fewer peers can be present. In a P2P network, all peers can potentially provide resources, including storage space and computing power. Thus, as additional peer nodes increase demand on the system, the total capacity of the system also increases. In a client-server architecture with a fixed number of servers, adding more clients can result slower data transfer to all clients. In contrast, the distributed nature of a P2P network makes it highly scalable. Thus, the techniques of the present invention are also applicable to peer networks with vast numbers of peers.

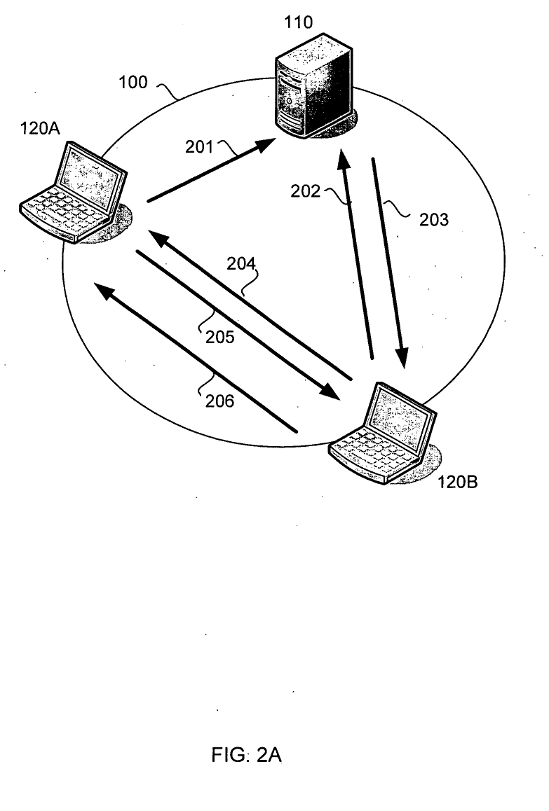

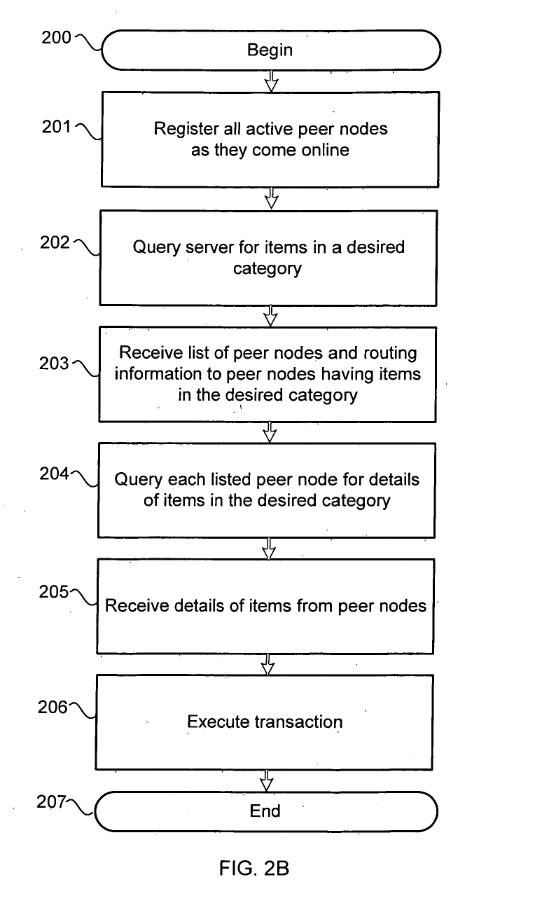

FIGS. 2A and 2B describe buying and selling goods over a P2P network 100. In one implementation, the P2P network and methods described herein provide a mechanism for buyers to locate and contact sellers who have items of interest. In one embodiment, a user operating any peer client device 120 running a P2P marketplace application may wish to sell an item, and any other user operating a peer client device 120 running a P2P marketplace application may wish to buy the item. As shown in the example of FIG. 2A, the seller is represented by peer client device 120A, and the buyer is represented by peer client device 120B. In one embodiment, each item that a seller is interested in selling is associated with a file residing on the seller's peer client device 120A that describes that item and/or provides details about the item. Alternatively, multiple items can be associated with a single file. Further alternatively or in combination with these approaches, the seller's offerings can be described in an XML or other structured document that is compatible across platforms. In another embodiment, a seller's offerings can be described in a database local to the seller's client device 120A, wherein each record in the database describes one of the seller's offerings, the database having for example, a relational or flat file format.

In one implementation, files describing items to sell can be imported from another program, for example, an inventory software application also running on the peer client device 120A. Methods and processes of adding items to inventories by selecting images to represent the items in the inventory database have been described in application Ser. No. 11/123,810, filed May 6, 2005, titled “Image-Based Inventory Tracking and Reports,” which is incorporated herein by reference in its entirety. According to those systems and methods, a user can import an image into an inventory application, and by selecting an image to represent an item to be added to the inventory, a new record is created in the inventory database. Within the inventory application, the user can add records of items, organize views of the data, and modify records of items all through the user's interaction with the image representing the item. Thus, in one embodiment, inventory records formed in the inventory application are configured so that they can be imported into the P2P marketplace application. In another implementation, the inventory software application is integrated with the P2P marketplace application. Thus, files or records associated with inventory items can be designated within the software application as being for sale. For example, a check box within the user interface can be selected to mark an item as being for sale, or the user can drag an inventory item or record for the inventory item to a location within the user interface that stores items that are for sale, for example, a bid management section of the marketplace application user interface. In one embodiment, subsequent bids and offers against an item marked for sale can appear within the user interface, allowing the user to accept an offer from another peer and transact the sale for the agreed-upon price.

As shown in FIG. 2B, after the method begins 200, as peer nodes, such as peer client device 120A, come online they register 201. In one implementation, peer nodes register with server 110, which stores data that identifies the types, categories or classifications in which the seller's offerings lie. In one example, the action of listing an item for sale sends a message to the server 110 notifying the server 110 that the given selling peer node has an item for sale within a given category. In one embodiment, the server 110 stores an index of IP addresses for client machines and the classifications of items that the seller at each of those IP addresses has for sale. The classifications are defined to be appropriate to the particular context or implementation of the P2P network. For example, in the context of a P2P network for pre-owned furnishings, the classification may be according to the room where the furnishings usually reside (e.g., bedroom, living room, kitchen, office, etc.). In the context of a P2P network that functions as a marketplace for a particular type of collectible, for example sports trading cards, the classifications may be according to sport and/or team. Depending on the context, the types, categories, or classifications may be more or less specifically defined. Any number of types, categories, or classifications can be used, and in one embodiment, the types, categories, or classifications can be hierarchical in nature.

In another implementation, peer nodes register with server 10, but sellers do not specify a category for the items for sale. Accordingly, in this implementation, there is no filtering based on the category of items for sale at a server. Rather, the server 110 stores information about the peer nodes that are currently online so that when a query is made, the query is sent to an initial set of online peers, and then, if additional results are desired, the query is forwarded to others as needed.

In another implementation, peer nodes do not register with server 110. Instead, a query can be broadcast to all P2P nodes within the P2P network or within the group. Alternatively, each peer can possess a list of, for example, a few thousand other peers, and the peers can broadcast the query to their own list of peers.

In one embodiment, the information stored for each peer node at the server 110 is refreshed each time that peer node connects to the network and undergoes registration. In another embodiment, the information stored for each peer node at the server 110 is updated periodically while the peer node is connected to the network. In general, the peer node is connected to the network to enable buyers to search the seller's offerings, and in one embodiment, the seller's offerings are not searchable when the peer node is not connected. In one embodiment, certain peer nodes may be connected continually to the P2P network 100, so that the items listed on these peer nodes are consistently available, whenever a buyer may choose to search. In one embodiment, sellers can elect to have items for sale hosted by a peer node that is continually connected to the P2P network 100. In one implementation, a hosting fee can be charged to the seller for this service.

In one variation, the P2P network 100 may be composed of several sub networks or groups of peer nodes. When a peer node connects to the network, the server 110 may determine the group or groups to which the peer node belongs. Alternatively, the peer node may identify the group or groups to which it belongs for the server 110 during registration. In another variation, part of the data stored by the server 110 identifies the group or groups to which each peer node belongs. For example, a group may be a private trading ring in which the peer network is limited to certain peer nodes for both buying and selling. As another example, an unlimited number of buyer peer nodes may access the offerings of a limited set of seller peer nodes in a group. A peer within a group can choose to send a request to only the participating members within the group rather than the entire P2P community at large. In this way, private and public trading groups or subsets of the entire P2P community allow for independent trading rings to be formed where goods and services are offered only to members within the group. In one implementation, participation in a group is controlled by a peer node that founds the group. Requests to join the group would be addressed by the founding peer node. Groups can be organized according to subject matter, according to geographical area, according to personal relationships, or according to any other criteria.

In step 202, a buyer, such as peer client device 120B, queries the server 110 for items in a desired category. For example, a buyer who is looking for a used cherry desk may query the server 110 for listings in the office furniture category.

In response to the buyer's query, the buyer receives a list of peer nodes and routing information to those peer nodes having items in the desired category 203. In one embodiment, the server 110 provides this information to the buyer by performing a lookup by category. In one implementation, the server 110 may send only a subset of the entire list of peer nodes that meet the criteria of the buyer's query. For example, the server 110 might send only the first 100 or 1000 hits. In one embodiment, the maximum number of hits returned is configurable by the buyer. In another embodiment, the data stored for certain peer nodes on server 110 indicate that those peer nodes should be given priority over other matching peer nodes. For example, certain peer nodes can be marked so that their routing information is always returned by the server 110 to buyers who query for a particular category, no matter how many other hits there are. In one implementation, users can pay an administration fee to be given this preferred treatment by the server 110. As another example, the server may return only hits to the buyer that correspond to members of the buyer's group or groups. In another variation, other filtering, grouping and sorting can be performed on the results of the query. In one embodiment, the list of peer nodes having items in the desired category is displayed to the buyer. In another embodiment, this list is not displayed.

In step 204, the buyer queries each listed peer node for details of items in the desired category. In one implementation, the step 204 of querying each listed peer node is performed automatically in response to the buyer receiving the list. In another implementation, step 204 is performed after the buyer has specified additional criteria for the search within the group of peers identified by the server's response to the buyer's initial query. For example, the server 110 may have returned a list of peer nodes with offerings in the office furniture category, but the buyer may specify additional criteria, such as the characteristics of the office furniture for which the buyer is searching, e.g., “cherry desk”. Queries may be keyword searches, image searches, or any other query format or method known to those of skill in the art. In one implementation, a buyer may specify that the search be limited to members of the group or groups to which the user belongs. In another implementation, the sellers indicate whether an item is available at a fixed price or available to whomever makes the best offer, with or without a hidden reserve price. Any of these criteria can be used in the query by the buyer and/or be included in the information that is conveyed in the search results to the buyer.

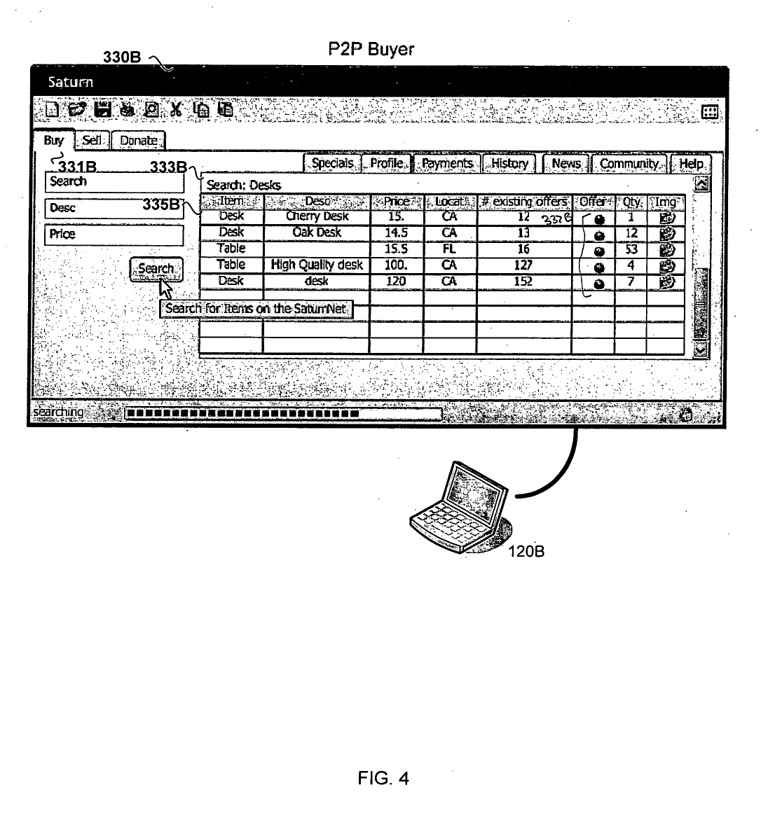

In step 205, the buyer receives details of items that match the buyer's query from sellers, such as peer client device 102A of FIG. 2A. In one embodiment, the details of the items can be displayed on the peer client device 120B for the buyer to review. An example user interface for the buyer's peer client device 120B will be described below with reference to FIG. 4. The buyer can review the detailed information associated with the item, such as the asking price, the condition of the item, and any other information about the item received from the seller, and select an item that the buyer wants to acquire. In one implementation, the buyer can also review any content, information, or documents related to that peer's offering that the peer desires to share. For example, a seller may attach a copy of the warranty document, the service record, a digital photograph, or any other information relevant to a particular item for sale. In another embodiment, the buyer may contact the seller through the peer network 100 to request more information about the item the buyer may be interested in purchasing.

In one embodiment, the buyer also receives information about the seller to use in deciding which item the buyer wants to acquire, such as the ratings the seller has obtained from a buyer/seller rating system incorporated into the marketplace application. In one implementation, users can link to a rating system, such as Zipingo, a web-based business rating system available at www.zipingo.com, offered by Intuit, Inc., of Mountain View, Calif., or other rating system that enables users to provide and view feedback other users have contributed. For example, within the marketplace application, Zipingo can be displayed in an embedded browser window to allow users to check the ratings and comments other peers have contributed as feedback about a particular buyer or seller based on a buyer's or seller's unique identification. Alternatively, ratings can be displayed in the marketplace application directly and transmitted along with the other information relevant to a particular item for sale. In another embodiment, ratings can be tracked for particular products and included as described above with the other information transmitted relevant to a particular item for sale.

In step 206, the buyer executes the transaction to purchase the desired item. In one embodiment, instructions on how to execute the transaction are included with the details received on the item from the seller. For example, the instructions may direct the user to deposit the payment in an escrow account or with an escrow agent identified by the seller. Alternatively, the seller may direct the buyer to send payment via a Paypal account or other payment service used for online commerce. As another example, the details received on the item may direct the user to the seller's website for related product offerings. Alternatively, the buyer and seller may barter goods or services, or use any other method of exchanging something of value for something else of value. Thus, in some embodiments, the actual sales transaction may occur over a communication channel outside of the P2P network.

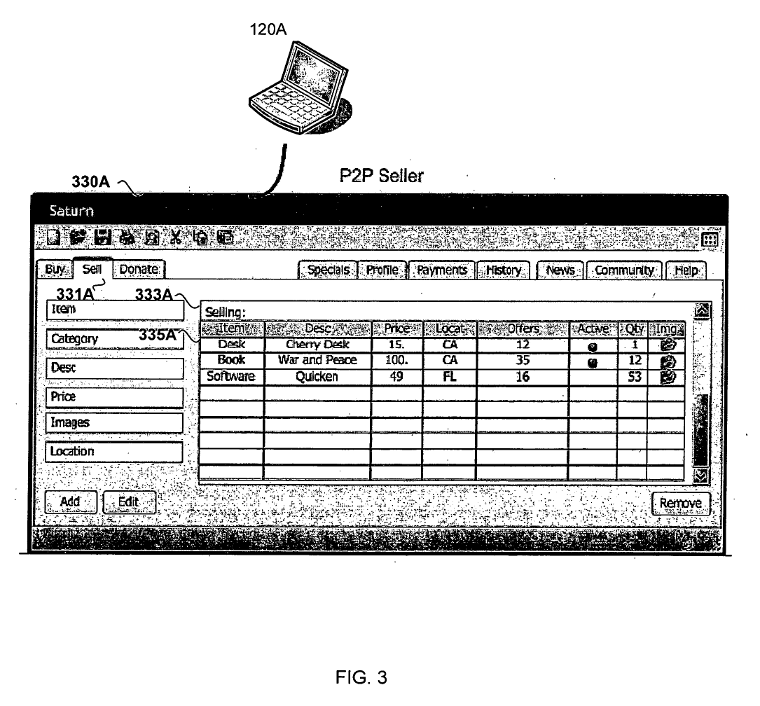

FIGS. 3 and 4 are presented as screen shots depicting examples of the user interface as it might appear on a display screen or other output device. The particular screen layouts, appearance, and terminology as depicted and described herein, are intended to be illustrative and exemplary, and in no way limit the scope of the invention as claimed. In these example screen shots, the buyer and seller are participating in an informal auction of a desk. The desk item 335A being sold by the seller appears as item 335B among the buyer's search results for desks on the P2P network.

FIG. 3 is an illustration of one embodiment of a user interface 330A of a client device 120A used to track items a seller offers for sale in a P2P network 100. The user interface 330A can include a table 333A of the items that the seller offers for sale. The user can display the table 333A of the items offered for sale by selecting the Sell tab 331A. The user interface 330A can be configured to have entries for any number of variables in the table 333A summarizing the items for sale. One of these items, a desk 335A, is an item potentially of interest to the buyer in this example. In this implementation, the seller is tracking an asking price and the number of offers that have been received for each item. In other implementations, the seller may track the asking price and the highest offer received, which would be similar to stating an asking price for an item and including an “or best offer” caveat. In some cases, the current high offer could be above or below the asking price. Unlike some formal auctions conducted for sellers on websites such as Ebay, in this embodiment, the seller is free to accept an offer at any time. In this example, the table 333A includes the item name, a short description of the item, the asking price of the item, the location of the item, the number of offers received from other peers on the peer network, an indicator has to whether the item is actively for sale, the quantity of the item, and a link to an image of the item. In this example, each record in the table, for example the record 335A for the desk item, includes a link to an image of the item. For example, the seller of the desk item 335A may have taken some digital photographs of the desk and loaded them onto the seller's client device 120A. In one embodiment, the user interface 330A also enables the seller to add, edit or remove items from the table 333A.

FIG. 4 is an illustration of one embodiment of a user interface 330B used to buy items in a peer-to-peer network 100. The user interface can include a table 333B that displays the items available for sale that have been identified by searching the peer network. The user can display the table 333B of the items available to be purchased by selecting the Buy tab 331B. In this example the table 333B includes the item name, a short description of the item, the asking price of the item, the location of the item, the number of existing offers on the item, a button 337B to select in order to make an offer on the item, the quantity of the item available, and one or more images of the item. The buyer can review the entries in the table 333B to decide whether to make an offer. In this embodiment, the buyer can easily compare the results of the search along many dimensions to make an informed decision. The buyer can make an offer to buy the item by selecting the button 337B corresponding to the item.

Embodiments of the present system allow an overall lower cost of goods due to the elimination of the intermediary and the ability to shop multiple locations at the same time which results in greater variety and ultimately greater value to the customer. The buyer can see offerings from businesses operating on the P2P network alongside offerings from individuals, and the buyer can compare results for both new and used items. Buyers are not required to remember or find specific websites to shop for items for sale. In some embodiments, they also need not risk an auction to purchase goods. This system provides quick information to buyers on items or services for which they searched, and the ability to contact the seller directly to execute the sales transaction.

Embodiments of the present system also allow multiple buyers to be aware of the seller's offerings easily and without a listing fee or other payment to an intermediary. The sellers can reach a targeted market that the seller knows is interested in the products that the seller has to offer because the buyers searched for them. In contrast to a centralized model, in a decentralized P2P model, the seller maintains control over the sales by adding and removing items at will, as easily as adding or taking an item off of a store shelf. Also, in some implementations, certain sellers may capitalize on the opportunity to increase exposure to the seller's other products. Sellers may direct buyers who receive details about one of the seller's items to the seller's other offerings through other distribution channels such as a customized website, a portal, or a brick and mortar store.

The above example described the present invention in the context of buying and selling goods in a P2P marketplace. The present invention is also useful in other contexts, such as buying and selling services, electronic want-ads, facilitating the donation of items, and scheduling appointments.

For example, in one variation, the present invention facilitates the donation of items to charitable organizations. Donors can list items that they desire to donate in a similar fashion to how sellers can list items for sale. In one implementation, items for donation are separately classified, and this data is conveyed to the server 110. Thus, a representative of a charity can search the peer network for items in the donation classification that meet the charity's needs and contact the donors directly to arrange the transfer. Alternatively, the donors could list items that the donor intends to give away along with items that the donor wishes to sell. The donor could mark the appropriate donation items, for example by listing the price of those items as free. Interested charitable organizations could then search for items of interest with the additional search criterion that the price be free. The resulting hits would be the cross-section of the items available for donation and the items that the particular charity wants to obtain. Alternatively or additionally, the system could be operated with the roles reversed. For example, representatives of charities can list items that they specifically need, and a prospective donor can search the peer network for organizations that need the item the donor desires to donate. Then the donor could compare the organizations and information appearing in the results to determine which charity or cause the donor prefers to support. Through leveraging the P2P model to facilitate donation, the donor can rest assured that her donation is reaching an appropriate charity for the type of donation she is making. She can quickly and easily dispose of items she does not need by directly contacting those who have indicated that they would appreciate the gift.

As another example, in another variation, the present invention facilitates the scheduling of appointments. Individuals or businesses can list their availability and the type of service they perform. For example, a hair stylist may list a number of openings he has for the week. A potential customer in need of a hair cut can search the peer network for a time slot that meets the customer's needs and contact the hair stylist directly, for example through the P2P network or by phone, to schedule the appointment for his desired time slot. In this example, the hair stylist leverages the P2P model to efficiently schedule his time by reaching a targeted audience for a low investment of time and money. The potential customer benefits by knowing that the hair stylist has an opening without having to call individual stylists to determine their availability first.

The present invention has been described in particular detail with respect to three possible embodiments. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet, public networks, private networks, or other networks enabling communication between computing systems.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A peer network marketplace comprising:
a network,
a plurality of peer nodes connected to the network, each peer node having an offering, each offering having a type, the type being one of a plurality of types, wherein the offering is one selected from a group consisting of a good and a service;
a server peer node connected to the network, the server peer node storing routing information to the plurality of peer nodes within the peer network marketplace and storing the type of each offering that each of the plurality of peer nodes has; and
a buyer peer node connected to the network, the buyer peer node receiving from the server peer node routing information to peer nodes that have offerings of a selected type, wherein the buyer peer node queries the peer nodes for offerings matching selected criteria, receives information describing offerings that match the selected criteria, and selects one of the offerings for a transaction involving the offering.

2. The peer network marketplace of claim 1, wherein each peer node registers with the server peer node when the peer node connects to the network.

3. The peer network marketplace of claim 1, wherein one of the plurality of peer nodes is connected continually to the network.

4. The peer network marketplace of claim 1, wherein the offering is an item for sale.

5. The peer network marketplace of claim 1, wherein the offering is an item for donation.

6. The peer network marketplace of claim 1, wherein the offering is an appointment with a service provider.

7. In a peer network marketplace comprising a plurality of peer nodes connected to a network, a server peer node comprising:
a storage containing routing information to the plurality of peer nodes within the peer network marketplace and the type of each offering that each of the plurality of peer nodes has, wherein the offering is one selected from a group consisting of a good and a service;
a receiving module for receiving a query from a peer node for routing information to peer nodes that have offerings of a selected type; and
a transmitting module for sending to the peer node the routing information to a group of the peer nodes, each peer node in the group having an offering of the selected type.

8. A method of buying a seller's offering in a peer network marketplace, comprising:
querying a server for routing information to peer nodes that have offerings of a selected type, the selected type being one of a plurality of types, wherein each offering is one selected from a group consisting of a good and a service;
responsive to the query, receiving routing information to a group of peer nodes, each peer node in the group having an offering of the selected type;
querying the group of peer nodes for offerings that match selected criteria;
receiving information describing the offerings that match the selected criteria; and
selecting one of the offerings to buy.

9. The method of claim 8, wherein the group comprises a portion of the peer nodes within the peer network that have offerings of the selected type.

10. The method of claim 9, wherein the group comprises the peer nodes registered with the server as belonging to the group.

11. The method of claim 8, wherein the group consists of peer nodes presently online.

12. The method of claim 8, further comprising receiving rating information about an offering that matches the selected criteria.

13. The method of claim 8, further comprising receiving rating information about a seller of an offering that matches the selected criteria.

14. The method of claim 8, further comprising executing a transaction to buy the offering.

15. A method of selling an offering in a peer network marketplace, comprising:
registering offerings stored on a first peer node with a server, each offering having a type, the type being one of a plurality of types, wherein each offering is one selected from a group consisting of a good and a service;
responsive to a query from a second peer node for offerings matching selected criteria, sending information describing an offering that matches the selected criteria to the second peer node;
receiving a request to buy the offering from the second peer node; and
transacting a sale of the offering.

16. The method of claim 15, wherein registering comprises registering offerings stored on the first peer node when the first peer node connects to a network.

17. The method of claim 15, further comprising sending rating information about an offering that matches the selected criteria to the second peer node.

18. The method of claim 15, further comprising sending rating information about a seller of an offering that matches the selected criteria to the second peer node.

19. The method of claim 15, wherein receiving a request to buy comprises receiving a bid for the offering.

20. The method of claim 19, wherein transacting a sale of the offering comprises selling the offering to a high bidder.

21. A computer program product for buying a seller's offering in a peer network marketplace, the computer program product stored on a computer readable medium and adapted to perform the operations of:
querying a server for routing information to peer nodes that have offerings of a selected type, the selected type being one of a plurality of types, wherein each offering is one selected from a group consisting of a good and a service;
responsive to the query, receiving routing information to a group of peer nodes, each peer node in the group having an offering of the selected type;
querying the group of peer nodes for offerings that match selected criteria;
receiving information describing the offerings that match the selected criteria; and
selecting one of the offerings to buy.

22. A computer program product for selling an offering in a peer network marketplace, the computer program product stored on a computer readable medium and adapted to perform the operations of:
registering offerings stored on a first peer node with a server, each offering having a type, the type being one of a plurality of types, wherein each offering is one selected from a group consisting of a good and a service;
responsive to a query from a second peer node for offerings matching selected criteria, sending information describing an offering that matches the selected criteria to the second peer node;
receiving a request to buy the offering from the second peer node; and
transacting a sale of the offering.
